(19) United States
(12) Patent Application Publication
(10) Pub. No.: US 2004/0265050 A1
(43) Pub. Date: Dec. 30, 2004

(54) Highly flexible extendable rod

(75) Inventor: Alfonso Branca, Milano (IT)

Correspondence Address: THE FIRM OF KARL F ROSS, 5676 RIVERDALE AVENUE, PO BOX 900, RIVERDALE (BRONX), NY, 10471-0900, US

(73) Assignee: TOP GLASS S.P.A.

(21) Appl. No.: 10/853,745

(22) Filed: May 25, 2004

(30) Foreign Application Priority Data
May 28, 2003 (IT) MI2003A001067

(51) Int. Cl. E04H 15/36; F16D 1/00; B25G 3/00; F16B 7/18; F16L 15/00

(52) U.S. Cl. 403/300

(57) ABSTRACT

The highly flexible extendable rod comprises a plurality of segments attached to each other through connection means adapted to align said segments when the said rod is in open position, and overlay said segments when the rod is in closed position.

The present invention relates to a highly flexible extendable rod, particularly adapted for supporting sheets as shelter for persons or objects, such as traditional camping tents, for example.

As is known, for current camping tents or any other types of fabric sheet shelters for various objects, rods divided into sections are often used, each section having a male and a female connection at each end to permit the insertion of the end of one section into the end of the adjacent section to form a rod of the required length.

In particular, said rod is normally composed of sections in tubular form, inside which a length of elastic cord is passed to maintain all the various sections attached to each other once the rod has been assembled, and to permit easy folding action by stretching the elastic cord and sliding the male element from the female element in adjacent sections in order to fold the sections, one alongside the other.

Once the various sections have been assembled together to form the rod of the required length, the rod is inserted in an appropriate seat realised in the fabric sheet or camping tent, and is blocked at each end to maintain the tent or sheet in an open position, thanks to the flexibility of the rod, thus forming a shelter and/or space for persons or objects.

However, rods formed in this manner present certain disadvantages, among which is the premature aging of the elastic cord inside the rod, which, if broken, means the rod can no longer be used and must therefore be eliminated.

Very often the elastic cord wears very rapidly and consequently, it is subject to premature rupture, resulting in the fact that the rod can no longer be used, as well as all the inconvenience this may cause for the user.

For example, camping tent users may find themselves unexpectedly with one or more rods that cannot be used, resulting in the fact that they may not be able to raise the tent even in cases of extreme necessity.

Furthermore, the presence of the elastic cord inside the rod can lead to an inconveniently shaped bundle when the sections are dis-assembled, that may occupy space that could be put to better use.

In addition, the presence of the elastic cord inside the rod can cause harm and/or damage to the user through unexpected and uncontrollable section movement while under elastic strain.

By no means the least disadvantage, is the fact that to insert the elastic cord inside the rod, said rod must be hollow and this leads to higher production costs and a weakening of rod structure above all when subject to heavy duty use.

The task of the present invention is to resolve the problems that exist in state of the art techniques.

In the context of this invention, an important aim is to realise a highly flexible extendible rod that stands up to hard wear over a long period of time, and that can be folded a large number of times without causing structural problems or a safety risk for the user.

A further aim of the invention is to realise a highly flexible extendable rod that, while occupying the same space as traditional rods, possesses greater structural resistance and also greater elastic flexibility, and that can therefore be used for any type of shelter or camping tent.

This task as well as this and other aims are achieved with a highly flexible extendable rod, characterised by the fact that it comprises a plurality of segments attached to each other through connection means adapted to align said segments when the said rod is in open position, and to overlay the segments on top of each other when said rod is in closed position.

Further characteristics and advantages of the invention will be explained in the description of a preferred but by no means exclusive embodiment of a highly flexible extendable rod according to this invention, illustrated in an indicative but by no means limitative manner in the appended drawings wherein:

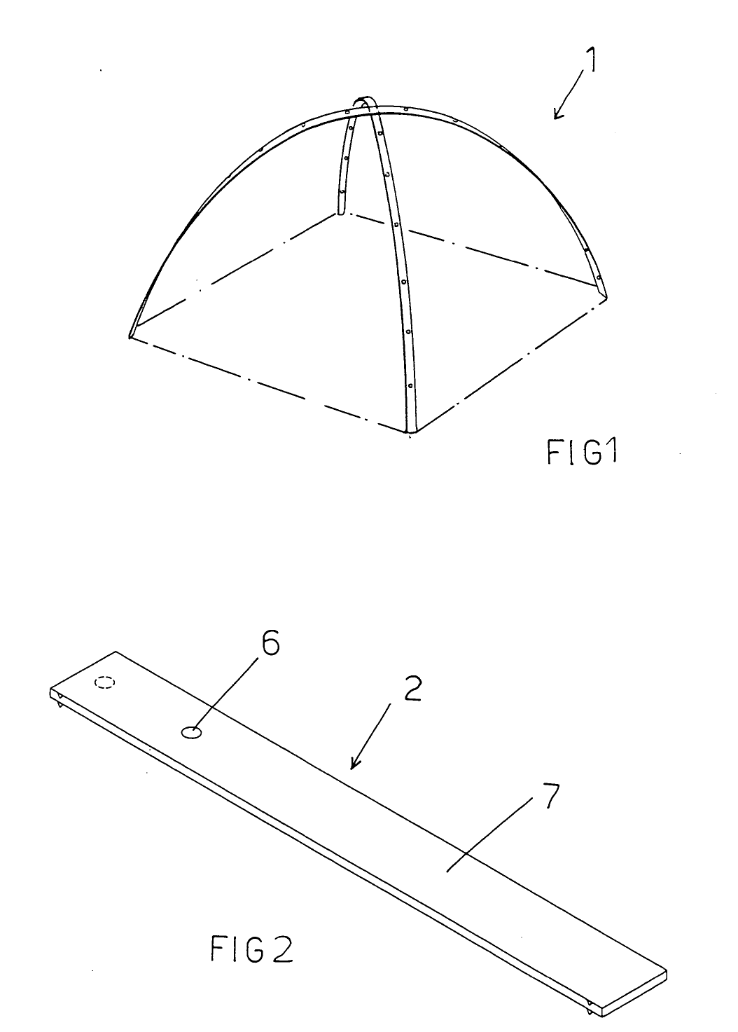

FIG. 1 shows a schematic view in perspective of a fabric shelter or a camping tent in which the support rods are visible according to the invention.

FIG. 2 shows a view in perspective, seen from above, of a segment that composes the rod according to the invention.

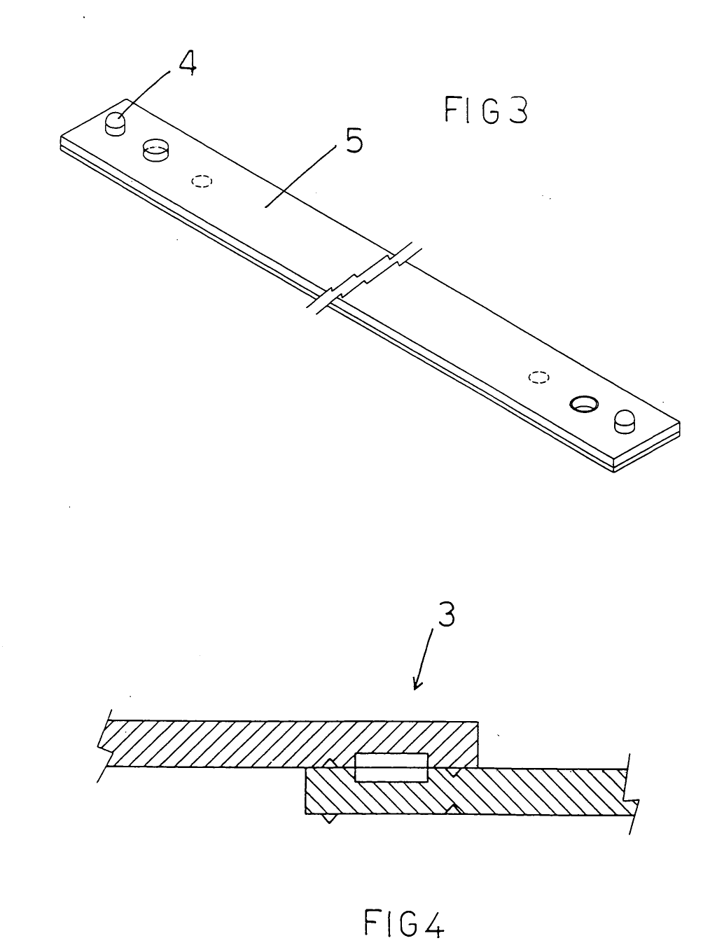

FIG. 3 is a view of the same segment shown in FIG. 2 seen from underneath, according to the invention.

FIG. 4 shows the connection of two adjacent segments according to the invention.

In all the aforesaid figures described, the highly flexible extendable rod according to the invention is identified throughout with the reference numeral 1, and is comprised of a plurality of segments attached to each other, each one being identified generally with the numeral 2.

The segments attached to each other through connection means, identified throughout by the numeral 3, adapted to align said segments when the said rod is in open position, and overlay the segments perfectly on top of one another when said rod is in closed position.

The segments 2, all have a flat and elongated configuration, are all identical to each other, and are realised in a material with very high flexibility capacity, preferably a compound material.

The segments all possess reciprocal click-in attachment means in the open and closed position, and in particular, have a protruding pin 4 located at the end of a first face 5 on each of the segments, as well as a corresponding seat 6 positioned at the end of the second face 7 on the other side of the first face.

The connection means comprise a male and a female element reciprocally independent of each other to permit rotation, but axially attached to each other.

More in particular, said connection means can be realised using a press-stud 8 or a click-in element for insertion into a hole for this purpose at the end of segment 2.

Whichever connection means 3 is adopted, said means will be arranged between each protruding pin 4 and the seat 6 in order to ensure that all segments 2 are identical, and to ensure the reciprocal connection without the need for previous preparation in a certain direction or arrangement.

In fact, the ends of the segments are overlaid on top of each other in a manner so that the protruding pin of one segment is engaged in a click-in mode inside the respective seat of the adjacent segment.

Furthermore, thanks to the flat configuration of the rod, it is possible to attach it to the shelter fabric or camping tent so that the first or second face is in contact with the fabric, thus distributing all stress in a homogeneous manner over a wide surface contributing towards longer rod life.

The manner in which the rod functions according to the invention is already clear from the description and the drawings.

In particular a number of segments 2 are attached to each other until the required rod length has been obtained.

Advantageously, with this method it is very simple and rapid to obtain a longer or shorter rod according to the curve required during tent assembly to provide exactly the configuration desired.

In the case a segment may be broken, it can be easily replaced by the user himself.

The realisation of the rod in compound material provides considerable mechanical corrosion resistance.

The finding as it has been conceived can be subject to numerous modifications and variants, while remaining all within the concept of the invention; furthermore all elements can be replaced with others technically equivalent.

Practically speaking, the materials employed, and the size and shape of the elements can be of any type according to requirements and the technical state of the art.

1. A highly flexible extendable comprising a plurality of segments attached to each other, adapted to align said segments when the rod is in open position and to overlay said segments when said rod is in closed position.

2. A rod according to claim 1 wherein said segments all possess a flat and elongated configuration.

3. A rod according to claim 2 wherein said segments are all identical to each other.

4. A rod according to claim 3 wherein said segments possess reciprocal click-in attachment means to maintain said segments in an open or closed position.

5. A rod according to claim 3 wherein said segments present click-in attachment means comprising at least one protruding pin located at the end of a first face of each of the said segments, and a corresponding seat located at the opposite end of said segment on the second face on the other side.

6. A rod according to claim 3 wherein said connection means comprise a male element and a female element reciprocally independent of each other to permit rotation, but axially attached to each other.

7. A rod Rod according to claim 3 the ends of said segments are overlaid on top of each other in a manner so that said protruding pin of one segment is inserted in click-in mode into said seat of the adjacent segment.

8. A rod according to claim 3 wherein said rod is engaged in an elastic manner in the shelter fabric in contact with either the said first or second face.

9. A shelter cover for persons or objects which comprises at least one elastically pliable rod as a support, presenting a flexible rod in compound material comprising a plurality of segments attached to each other through connection means adapted to align said segments when the rod is in open position, and to overlay said segments when said rod is in closed position, said segments each having a flat and elongated configuration, and all being identical to each other, and presenting a reciprocal attachment click-in means in said open and closed positions.
